(19) United States
(12) Patent Application Publication
(10) Pub. No.: US 2026/0277782 A1
(43) Pub. Date: Sep. 17, 2026

(54) LOW LATENCY CLOUD-BASED DEBUGGING USING PREDICTED DEBUGGING OPERATIONS

(71) Applicant: SONY INTERACTIVE ENTERTAINMENT INC., Tokyo (JP)

(72) Inventors: Kelvin Yong, Irvine, CA (US); Michael Stopa, San Mateo, CA (US); Harshil Shah, Yorba Linda, CA (US); Xiaoyong Ye, Pleasanton, CA (US)

(21) Appl. No.: 19/076,914

(22) Filed: Mar. 11, 2025

(51) Int. Cl. G06F 11/3698; A63F 13/40; G06F 11/362

(52) U.S. Cl. CPC G06F 11/3698; A63F 13/40; G06F 11/3624

(57) ABSTRACT

Circuits, methods, and code can reduce latency from a cloud server system to a developer by pre-processing and caching a number of possible outcomes. For example, a method performed by a cloud server system executing a gaming application can include determining that a remote client device is executing an integrated development environment in a debugging mode for code associated with the gaming application. In response, the method can include determining a set of available debugging steps for the code in the debugging mode. The method can include generating, for each debugging step in the set of available debugging steps, an output by executing an associated portion of the code. The method can include detecting, from the remote client device, a selected debugging step from the set of available debugging steps. The method can include, responsive to detecting the selected debugging step, providing the associated output to the remote client device.

### BACKGROUND

Modern game consoles, such as the PlayStation® 5 video game console, are sophisticated machines capable of providing engaging video game and entertainment experiences. A game console helps to streamline the gaming industry by providing a common platform of standardized resources (e.g., hardware and software) for the development, distribution, and execution of video games. In this manner, game developers can optimize their game development for the game console, and provide consumers with a seamless video game experience devoid of concerns about video game compatibility, optimization, or complicated setup with respect to the platform on which the game is run.

A fairly recent development enabled by the proliferation of the Internet is the rise of cloud gaming, in which a video game is executed remotely (e.g., in a remote data center), with gameplay being streamed over the Internet to a user's local client device. More specifically, gaming inputs are transmitted from the client device over the Internet to the cloud executed video game, and the gameplay video generated by the video game is streamed over the Internet to the client device for rendering on a display.

Game development can also be performed remotely via remote data centers. For instance, game development kits can be executed by the remote data centers. But issues may arise when adapting specialized game development systems for cloud-based development.

### BRIEF DESCRIPTION OF THE DRAWINGS

The disclosure may be better understood by reference to the following description taken in conjunction with the accompanying drawings in which:

FIG. 1 illustrates an example computing environment for cloud game development and debugging, according to an embodiment of the present disclosure.

FIG. 2 illustrates an example of a computing environment for cloud game development and debugging using a large language model, according to an embodiment of the present disclosure.

FIG. 3 illustrates an example of a gaming console streaming pre-computed gaming options, according to an embodiment of the present disclosure.

FIG. 4 illustrates an example flow for performing cloud game development and debugging, according to an embodiment of the present disclosure.

FIG. 5 illustrates an example computing environment for cloud game development and cloud game streaming, according to an embodiment of the present disclosure.

FIG. 6 illustrates an example of a computer system suitable for implementing techniques of the present disclosure, according to embodiments of the present disclosure.

In the appended figures, similar components and/or features can have the same reference label.

### DESCRIPTION OF ILLUSTRATIVE EMBODIMENTS

Embodiments of the present disclosure are directed to, among other things, low latency cloud-based debugging of game engines. In some examples, a developer may develop software code for a gaming application (e.g., a video game). During development, the gaming application may be remotely executed, such as via a cloud server system. The developer may access an integrated development environment on a local computing device that is in communication with the cloud server system that is executing the software code for the gaming application. As part of developing the gaming application, the integrated development environment may be executed in a debugging mode for identifying and correcting bugs in the code. In some examples, the debugging mode may provide a constrained set of debugging steps that can be taken by the developer. To reduce latency in cloud-based debugging, the cloud server system may preemptively (e.g., before any debugging steps are selected) compute each debugging step and cache the resulting outputs. When the developer selects one of the debugging steps, the cloud server system can access the cached associated output and provide the associated output to the developer's local computing device.

To illustrate, consider the following example. A developer may use a local client device to develop a gaming application that can execute on a game engine. Rather than executing the code for the gaming application on a local gaming console with a direct network connection to the local client device, the game engine may instead be run on a cloud server system that is remote from the local client device. The local client device may use the Internet or other network to interact with the cloud server system to remotely develop the gaming application. Metadata, debugging data, game state data, frame renders, and the like can be transmitted between the local client device and the cloud server system as part of using an integrated development environment.

For example, the developer may use the integrated development environment to modify and/or debug code for the gaming application. Such modifications or debugging operations can involve using the client device to send commands to the cloud server system. The cloud server system may execute the commands and may transmit results of the commands back to the local client device. But such data transmission may result in significant latency due to physical distance between the local client device and the cloud server system and, in some cases, due to the size of data being transmitted. For instance, command results may involve frame renderings of the video game application, game state information, etc. Many debugging operations may be performed step-by-step. If commands to the cloud server system take long enough to execute, the developer may be unsure of whether a command was received by the cloud server system. The developer may erroneously believe that the command was not sent or received and may send another command, which may conflict with the previously sent command and result in computing errors or further delays in debugging the code.

To prevent such latency issues, the cloud server system may perform pre-processing of debugging steps in the debugging mode. In a non-limiting example, as the code is being debugged step-by-step (e.g., line-by-line), there may be a constrained set of steps that can be taken next for a particular line in the code. For example, such a set of steps may include “step into” (e.g., stepping into execution of a function in a current line of code), “step over” (e.g., executing the current line of code without entering any function calls), and “step out” (e.g., executing code until the currently executed function is returned). Only one of the set of steps may be selected to proceed with debugging.

When the cloud server system detects a set of available debugging steps, before any of the steps are selected, the cloud server system can automatically compute outputs for each of the available steps. For example, the cloud server system can compute three different instances in which the current line of code is either debugged with “step into,” “step over,” or “step out of.” The results for each of the instances can be cached. Then, when the client device transmits a command selecting one of the available debugging steps, such as “step into,” the cloud server system can automatically transmit the output to the client device. For example, the output may be an updated rendering frame of the gaming application (e.g., as a result of stepping into a function in the current line of code). Automatically transmitting the output without having to wait to generate the output until the command is received may significantly reduce latency in debugging the gaming application (e.g., latency from transmitting data between the client device and the cloud server system).

Similar techniques can also be applied to cloud gaming scenarios in which a player is using a gaming console to stream video game content from the gaming application. The gaming application may be executed by the cloud server system. The video game content may present a constrained set of gaming inputs that can be selected by the player (e.g., via a video game controller). For example, the set of gaming inputs may include possible movements for a video game character, such as moving one unit of distance to the right or left. Or, the set of gaming inputs may include a set of menu options, such as exiting the game, loading up an options menu, returning to a main menu, etc. The cloud server system can preemptively generate outputs for each of the options, which may include game states, frame renderings, etc. When the player makes a selection via the video game controller, the cloud server system may transmit the associated pre-computed output, such as by streaming the frame rendering displaying the updated movement or menu selection to the video game console. Additionally or alternatively, the cloud server system can preemptively generate outputs for the constrained set of gaming inputs in a cloud development scenario, such as when a developer is debugging the gaming application.

In the interest of clarity of explanation, the embodiments can be described in connection with debugging video gaming applications, such as those executed by gaming consoles. However, the embodiments are not limited as such and can similarly apply to debugging any other type of debugging for any type of application executed by any type of computer system. Additionally, the embodiments may similarly apply to game play or other client (e.g., player) interactions with any type of application, such as video gaming applications.

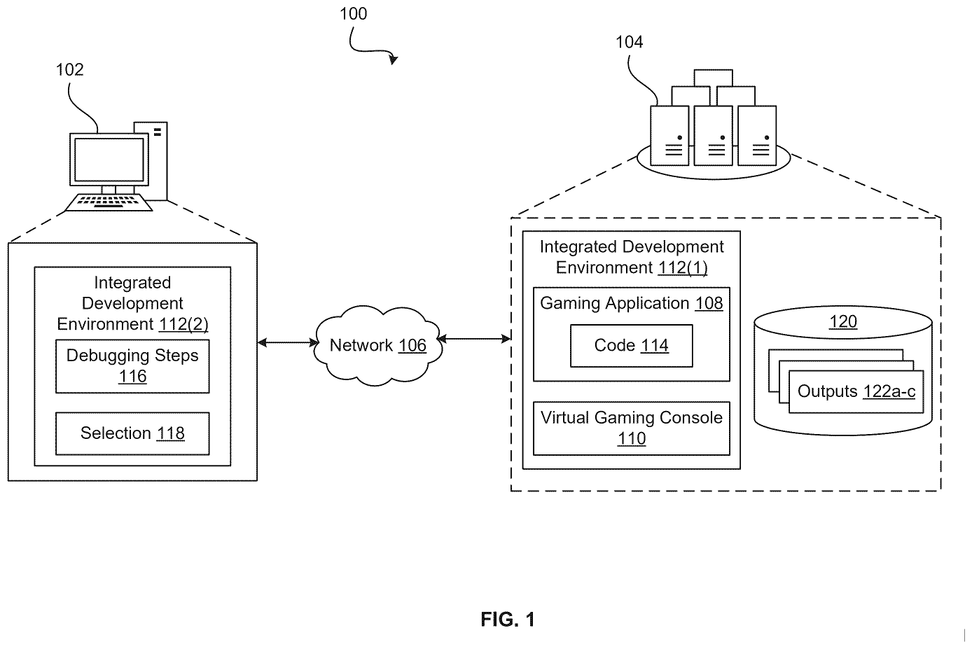

FIG. 1 illustrates an example computing environment 100 for cloud game development and debugging, according to an embodiment of the present disclosure. The computing environment 100 can include a client device 102 and a cloud server system 104 communicatively connected via a wireless network 106 (e.g., the Internet). The cloud server system 104 can execute a gaming application 108 (e.g., a video game application). In some examples, the cloud server system 104 can host a virtual gaming console 110 to execute the gaming application 108. The virtual gaming console 110 may be a virtualized instance of a physical gaming console, such as the PlayStation® 5.

The gaming application 108 may be in development. For instance, the code 114 of the gaming application 108 may be in review or be getting modified by developers, such as a developer operating the client device 102. To develop the gaming application 108, the cloud server system 104 can also execute a version of an integrated development environment 112 (e.g., integrated development environment 112(1)) that can be used to debug the code 114 of the gaming application 108.

The client device 102 can execute another version of the integrated development environment 112 (e.g., integrated development environment 112(2)) to interact with the integrated development environment 112(1) hosted by the cloud server system 104 (e.g., to debug the code 114). For example, the client device 102 may send debugging commands via the integrated development environment 112(2) to the cloud server system 104. The cloud server system 104 can execute the debugging commands by executing, skipping, modifying, etc., associated portions of code 114 for the gaming application 108. Executing the code 114 in the debugging mode can modify or otherwise produce an output of the gaming application 108. Such output may involve rendering an updated frame of the gaming application 108, updating a game state, etc.

Because data is transmitted between the client device 102 and the cloud server system 104 via the wireless network 106, and in some cases may be separated by hundreds or thousands of miles, significant latency may occur in transmitting such data. The cloud server system 104 may receive a command, spend time processing the command by executing an associated line of code 114 to generate an output, and then transmit the output back to the client device 102. Depending on the distance, network bandwidth, amount of computing resources used to generate the output, or other such factors, it may take several milliseconds, seconds, minutes, or more for the cloud server system 104 to fulfill commands from the client device 102. In gaming or debugging, it may be beneficial to reduce network latency to below 20 milliseconds.

Thus, to reduce latency in debugging the gaming application 108, the cloud server system 104 can compute and cache potential outputs for debugging the gaming application 108 before commands are received from the client device 102. For, the client device 102 may enter a debugging mode of the integrated development environment 112(2) (e.g., by executing a debugger). In some examples, in the debugging mode, lines of the code 114 may be executed in sequence (e.g., line-by-line) to identify and correct bugs. Depending on features of the code 114, there may be multiple next steps that may be taken in executing the current line of the code 114. The available debugging steps may, in some examples, be a constrained set of steps from which a selection can be made.

For example, the current line of code 114 may include a function. To test the function, multiple actions may be taken, including “stepping into” the function, “stepping over” the function, and “stepping out” of the function. “Stepping into” a function can involve executing a current line of code 114 if it is a function call. The integrated development environment 112(1) can then pause execution of the code 114 at the first line of the called function. “Stepping over” a function can involve executing the current line of code 114 and pausing on the next line of code 114, without executing any function on the current line of code 114. “Stepping out” of a function can involve continuing execution of code 114 until execution involves exiting a current function (e.g., skipping remaining lines of the current function to step out of the current function). Each of “step over,” “step out,” and “step into” can be debugging steps 116 that are available for selection by the client device 102 to continue the debugging process.

Before a command is received from the client device 102 selecting one of the available debugging steps 116, the cloud server system 104 may execute each of the potential debugging steps 116. For example, after execution of an initial debugging step, the cloud server system 104 may detect that a next line of code can be executed according to the available debugging steps 116. Upon detection of the available debugging steps 116, the cloud server system 104 may generate an output 122 for each of the available debugging steps 116. That is, a first output 112a can be generated by executing the “step into” debugging step, a second output 112b can be generated by executing the “step over” debugging step, and a third output 112c can be generated by executing the “step out” debugging step. The outputs 112a-c may include updates to game state of the gaming application 108, updates to frame rendering produced by executing the code 114 according to each of the available debugging steps, or any other suitable outputs generated by executing a gaming application 108.

The cloud server system 104 may store each of the outputs 122a-c in a cache 120 hosted by the cloud server system 104. Meanwhile, the available debugging steps 116 may be presented (e.g., displayed) for selection on the client device 102. The developer may input a selection 118 of one of the debugging steps 116, such as “step into.” The selection 118 may be transmitted as a command from the client device 102 to the cloud server system 104. When the cloud server system 104 receives the command to perform the selected debugging step, the cloud server system 104 can transmit the associated output (e.g., output 122a), which has already been generated, to the client device 102 via the wireless network 106. Transmitting an output 122 that has already been generated before a selection 118 was made or transmitted to the cloud server system 104 can significantly reduce latency involved in debugging the gaming application 108. In some examples, latency in responding to the selection 118 may be reduced to milliseconds or faster (e.g., below 20 milliseconds).

In some examples, outputs that are not selected by the client device 102 (e.g., outputs 122b-c) may be removed from the cache 120 once the selection 118 is received by the cloud server system 104. In some examples, outputs 122a-c may persist in the cache 120 even after multiple subsequent debugging steps have been performed. Such stateful information may then be used to “step backward” in the debugging process. For example, a selection 118 may have previously been made to “step over” a function in a particular line of code 114, and then several subsequent debugging operations may have been performed, advancing to other lines of codes beyond the particular line of code 114. The developer may wish to go back and start debugging again from the particular line of code 114 to make a different selection, such as to “step into” the function in the first line of code 114. Rather than having to restart execution of the entire section of code 114 to reach the particular line of code 114, the cloud server system 104 may roll back debugging to the particular line of code 114 using stored outputs 122a-c in the cache 120 (e.g., to restore the debugging process to the previously existing state before the particular line of code 114 was executed). The client device 102 may then make a different selection than the original selection, such as by selecting to “step into” the function in the particular line of code 114. Rolling back debugging to a previous state may also reduce latency in the debugging process and reduce consumption of computing resources compared to restarting the entire debugging process for the gaming application 108.

Although the debugging steps 116 in FIG. 1 have been described with respect to stepping into, out of, or over functions, techniques described herein may equivalently apply to any suitable set of available debugging steps for a gaming application 108.

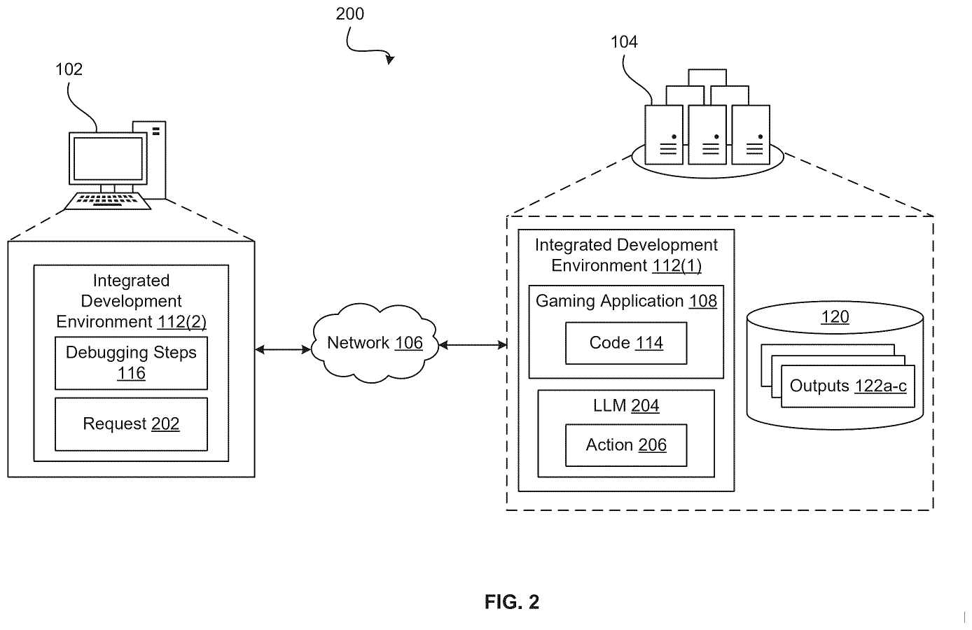

FIG. 2 illustrates an example of a computing environment 200 for cloud game development and debugging using a large language model, according to an embodiment of the present disclosure. The computing environment 200 may be an example of the computing environment 100 of FIG. 1. For example, the computing environment 200 may include a client device 102 that can interact with an integrated development environment 112 hosted by a cloud server system 104 to perform debugging processes on code 114 of a gaming application 108. The client device 102 may be communicatively coupled with the cloud server system 104 via a wireless network 106 such as the Internet. Upon detection of available debugging steps 116 that can be executed for a current line of code 114 in a debugging process, the cloud server system 104 can pre-compute outputs 122a-c for each of the available debugging steps 116. The pre-computed outputs 122a-c can be stored in a cache 120 to be accessed and provided to the client device 102 upon receiving a selection of one of the debugging steps 116 from the client device 102.

In addition, the cloud server system 104 may execute a large language model 204 as part of the integrated development environment 112(1). The large language model 204 can be an agent that can be trained to process and understand natural language prompts, such as a request 202 from the client device 102. The large language model 204 can also be trained to perform or trigger execution of an action 206 based on processed natural language prompts. In particular, the large language model 204 may assist the developer in debugging the code 114 of the gaming application 108.

For example, the developer may enter a natural language request 202 into an agent of the integrated development environment 112(2) executed by the client device 102. In a particular example, the request 202 may state “step over the function in line 247 of the code.” The request 202 can be transmitted via the wireless network 106 to the cloud server system 104. The cloud server system 104 can execute the large language model 204 to generate an action 206 based on an input of the request 202. For instance, the action 206 may be to automatically access an output 122 from the cache 120 and transmit the output 122 to the client device 102. By having the developer access the integrated development environment 112 via the large language model 204, the perceived negative effects of latency may be reduced compared to selecting an option. For instance, a developer may be less likely to repeatedly submit selections due to an erroneous belief that the selections are not being transmitted when interacting with a large language model agent. This can reduce unnecessary consumption of computing resources for the computing environment 200.

The large language model 204 can also be used to “roll back” the debugging process. For example, the debugging process may have continued to additional lines, such as to line 300. The client device 102 may then transmit a natural language request 202 asking to return the debugging process back to a previous state, such as to line 247, to “step into” the function rather than “step over” (as previously chosen). Because the output for “stepping into” the function in line 247 was saved in the cache 120, the action 206 generated by the large language model 204 may be executed by automatically transmitting that output 122 to the client device 102 without having to recompute the debugging processes for lines 1-247.

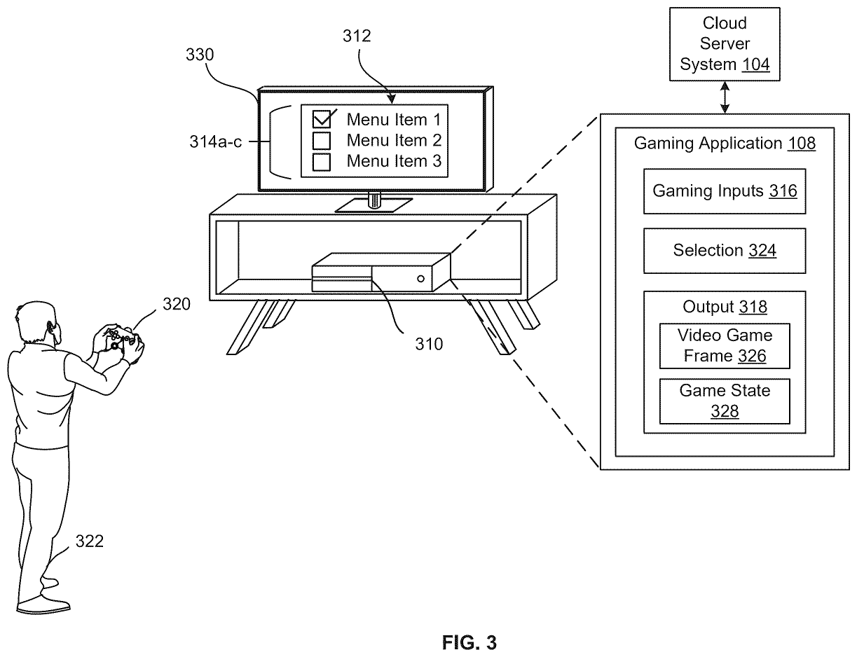

FIG. 3 illustrates an example of a gaming console 310 streaming pre-computed gaming options, according to an embodiment of the present disclosure. Gaming console 310 can be communicatively coupled to a video game controller 320 via an input port and a display port 330 via an output port. Although not shown, gaming console 310 can also be communicatively coupled to a backup system, such as cloud server system 104, via a network port. Gaming console 310 can be communicatively coupled with a video game controller 320 (e.g., over a wireless network) and with display 330 (e.g., over a communication bus). A user 322, such as a video game player, can operate video game controller 320 to interact with gaming console 310. These interactions can include playing a gaming application 108 (e.g., a video game application) that is presented on display 330 or interacting with other applications of gaming console 310 (e.g., with a content application that can stream content, such as videos, articles, images, social media feeds, podcasts, audiobooks, email, messages, or any other content from an online content source or to play or otherwise present storage from the local storage of gaming console 310).

The gaming console 310 includes a processor and a memory (e.g., a non-transitory computer-readable storage medium) storing computer-readable instructions that can be executed by the processor and that, upon execution of the processor, cause the gaming console 310 to perform operations related to various applications. In particular, the computer-readable instructions can correspond to program codes for the various applications of the gaming console 310, including the gaming application 108. The virtual gaming console 110 can be a virtualized version of the physical gaming console 310.

A video game application, such as video game application 140, generally represents a computer application executable to present video game content, receive user interaction with the video game content, and accordingly update the video game content. Further, other applications can be likewise included in the gaming console 310, such as a chat application, media application, etc. the availability of the gaming application 108, media application, and/or other type of computer application to the user 322 via the gaming console 310 can depend on a user identifier of the user 322 (e.g., upon a login to the gaming console 310, the availability of the computer applications can depend on the user identifier used in the login). In some examples, the gaming console 310 and/or the gaming application 108 can include a menu application 312. The menu application 312 can present a user interface (UI) in a graphical user interface (GUI) of the display 330.

The video game controller 320 is an example of an input device. The video game controller 320 may allow the user 322 to interact with one or more GUIs presented by the gaming console 310 on the display 330. For example, using one or more directional control inputs (e.g., a joystick and/or a directional pad) the user 322 can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 322 to interact with the GUIs using various voice commands. As another example, a camera may allow the user 322 to interact with the GUIs using various gesture commands.

Upon an execution of the gaming application 108 by the gaming console 310, a rendering process of the gaming console 310 presents video game content on the display 330. Upon receiving user input (e.g., gaming input 316) from the video game controller 320 (e.g., a user push of a particular key or button), the rendering process also presents menu items 314a-c. additionally or alternatively, the menu items 314a-c may be presented as an initial landing page in response to a user powering on the gaming console 310 and/or waking the gaming console 310 from a suspended state. Depending on the gaming inputs 316, the menu items 314a-c may correspond to the home UI page, a landing page, or the like. The menu items 314a-c may be presented in a layer over video game content.

In the example depicted in FIG. 3, the gaming application 108 may no longer be in development (e.g., as depicted in FIGS. 1-2). But, the cloud server system 104 may still cache potential outputs for reduced latency in streaming the gaming application 108 to the gaming console 310 (e.g., for presentation on the display 330). For example, the cloud server system 104 may detect when the gaming application 108 is presenting a constrained set of options (e.g., available gaming inputs 316) to the user 322 via the display 330. Before the user 322 selects one of the available gaming inputs 316, the cloud server system 104 can generate and cache an output 318 for each of the available gaming inputs 316.

For example, as depicted in FIG. 3, the gaming application 108 may be executing a menu application 312 that presents three menu items 314a-c on the display 330. Selection of the different menu items 314a-c may result in different video game content streamed to the gaming console 310. Upon detecting that the menu application 312 is executing, the cloud server system 104 can generate the outputs 318 resulting from selection of each of the menu items 314a-c. When the user 322 makes a selection 324 of one of the menu items 314a-c (e.g., by using the video game controller 320), such as first menu item 314a, the selection 324 can be transmitted to the cloud server system 104. The cloud server system 104 can then automatically access and transmit the associated output 318 for first menu item 314a to the gaming console 310. The output 318 may include, for example, a rendering of a video game frame 326 resulting from selecting first menu item 314a. The output 318 may also include related game information such as the game state 328. Such techniques may significantly reduce latency in cloud gaming.

Any other suitable gaming inputs 316, such as for constrained sets of gaming inputs, may also be pre-computed and automatically transmitted to the gaming console 310. For example, the pre-computed gaming inputs 316 may include a constrained set of movements for a character in the gaming application 108. Such a constrained set of movements may include moving one unit of distance to the left, right, or upwards (e.g., in a two-dimensional platformer game).

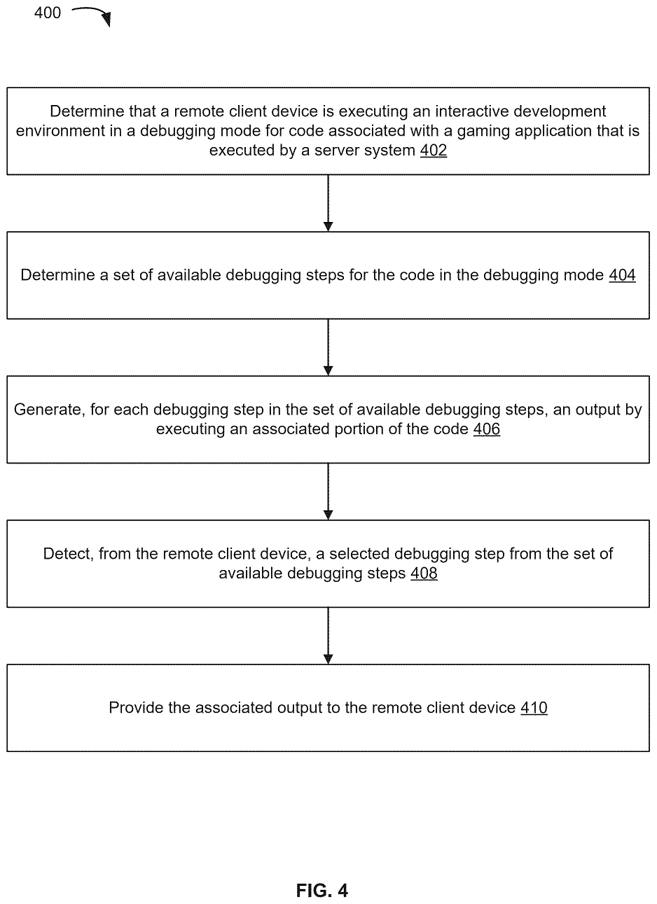

FIG. 4 illustrates an example flow 400 for performing cloud game development and debugging, according to an embodiment of the present disclosure. The operations of flow 400 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, flow 400 includes operation 402, where a cloud server system that can execute a gaming application can determine that a remote client device is executing an integrated development environment in a debugging mode for code associated with the gaming application. The debugging mode may, in some examples, involve executing lines of code or portions of lines of code in a step-by-step fashion, such as line-by-line. The remote client device may be remotely communicating with the cloud server system via a wireless network, such as the Internet.

In an example, flow 400 includes operation 404, where the cloud server system can, responsive to determining that the remote client device is executing the integrated development environment in the debugging mode, determine a set of available debugging steps for the code in the debugging mode. In some examples, the set of available debugging steps may be a constrained set. That is, the set of available debugging steps may be the only available steps that can be taken next in a line-by-line debugging process. In an example, the set of available debugging steps can include at least one of stepping over a function in the code, stepping into a function in the code, or stepping out of a function in the code. The cloud server system may identify the set of available debugging steps upon finishing execution of a prior debugging step.

In an example, flow 400 includes operation 406, where the cloud server system can generate, for each debugging step in the set of available debugging steps, an output by executing an associated portion of the code. In some examples, the output for each debugging step can be generated prior to detecting that the remote client device has selected one of the available debugging steps. Generating the output can include, for example, at least one of generating a game state for the gaming application or generating a rendering of a video game frame for the gaming application. In some examples, the cloud server system may store the outputs for subsequent retrieval, such as in a cache.

In an example, flow 400 includes operation 408, where the cloud server system can detect, from the remote client device, a selected debugging step from the set of available debugging steps. In some examples, detecting the debugging step can involve receiving, from the remote client device, a natural language request indicating the selected debugging step. The cloud server system can then generate, at least by executing a large language model, an action to be performed based on the natural language request.

In an example, flow 400 includes operation 410, where the cloud server system can, responsive to detecting the selected debugging step, provide the associated output to the remote client device. For example, the rendering of the video game frame that results from executing the selected debugging step can be accessed (e.g., from storage in the cache) and streamed over the wireless network to the remote client device. In some examples, the cloud server system may automatically access and provide the associated output in response to detecting the selected debugging step.

In some examples, similar techniques can be applied outside of a debugging environment and to a cloud gaming environment. For example, the output may be a first output. The cloud server system may determine that a gaming console that is communicatively coupled with the cloud server system is streaming content of the gaming application. The cloud server system may determine a set of available gaming inputs that are selectable in the gaming content. Such available gaming inputs may be, in some examples, a constrained set of gaming inputs. That is, a discrete number of gaming inputs may be selectable to continue interacting with the gaming application. Thus, for each gaming input in the set of available gaming inputs, the cloud server may generate a second output by executing the gaming application.

The second outputs may be generated prior to receiving or detecting a selection from the gaming console. Then, the cloud server system may detect, from the gaming console, a selected gaming input from the set of available gaming inputs. The cloud server system can then, responsive to detecting the selected gaming input, provide the associated second output to the gaming console. In some examples, the cloud server system can automatically provide the associated second output in response to detecting the selected gaming input.

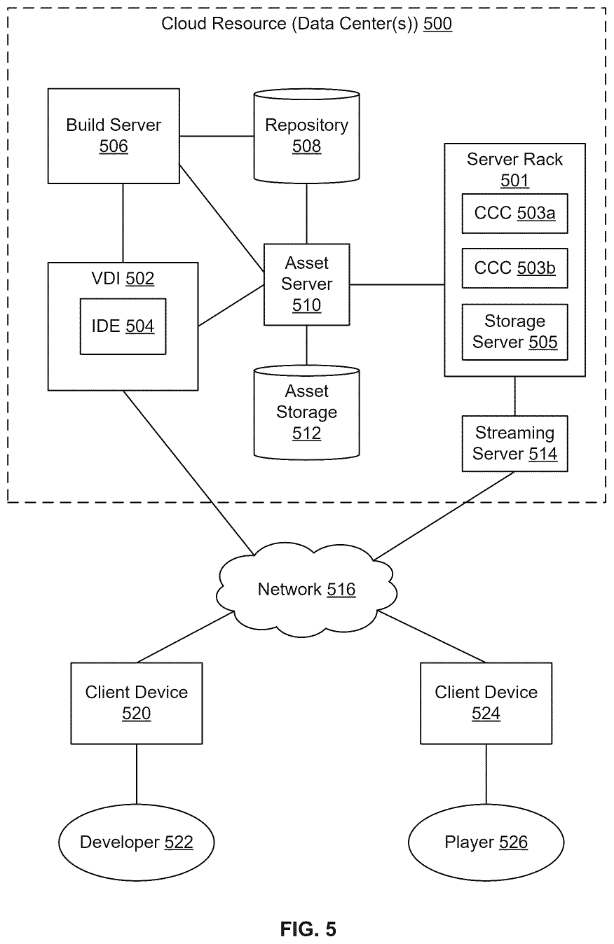

FIG. 5 illustrates an example computing environment for cloud game development and cloud game streaming, according to an embodiment of the present disclosure. In the illustrated implementation, a cloud resource 500 having cloud processing and cloud storage resources is provided. The cloud resource 500 can be an example of the cloud server system 104 of FIGS. 1-3. In various implementations, the illustrated systems can be implemented in one or more data centers, connected over the Internet. For example, a server rack 501 can be implemented in a data center, and a given console compute card 503a can be assigned to a player 526 and client device 524 for gameplay of a given console video game title. The player 526 can be an example of the user 322 of FIG. 3 and the client device 524 can be an example of the gaming console 310 of FIG. 3. The console compute card 503b will be loaded with the video game title, and gameplay will be streamed over network 516 (including the Internet) to the player's client device 524. In some implementations, a streaming server 514 is implemented to manage video streaming to the client device 524, for example, to optimize the video stream for network conditions, the player's hardware capabilities, etc.

In some implementations, a cloud-based game development platform is enabled by using the console compute cards in conjunction with game development systems. For example, a virtual desktop infrastructure 502 can be implemented that allows a developer 522 operating their client device 520 to access over network 516 a virtual desktop providing cloud-hosted tools for game development, such as an integrated development environment 504 or other development software (e.g., 3D rendering/animation software, etc.). The client device 520 may be an example of the client device 102 of FIGS. 1-2. An asset server 510 manages access to an asset storage 512 containing game assets such as textures, rigs, animations, audio, etc. A build server 506 manages access to various builds of video games, stored to a repository 508. The build server 506 can manage access to source code files, and compile source code into executables for deployment onto the console compute cards.

When a given executable build of a video game is executed by a console compute card, then the gameplay of the game build can be cloud streamed as previously described. For example, the player 526 may be a quality assurance (QA) tester or alpha/beta tester involved in supporting the development of the video game. In this manner, a cloud environment for end-to-end game development of console-based games is enabled, whereby game assets and builds are developed in the cloud, and testing on console-equivalent hardware is also cloud-based. This enables development teams and individuals, including software developers, artists, QA testers, project managers, etc. to engage and collaborate in game development activities remotely.

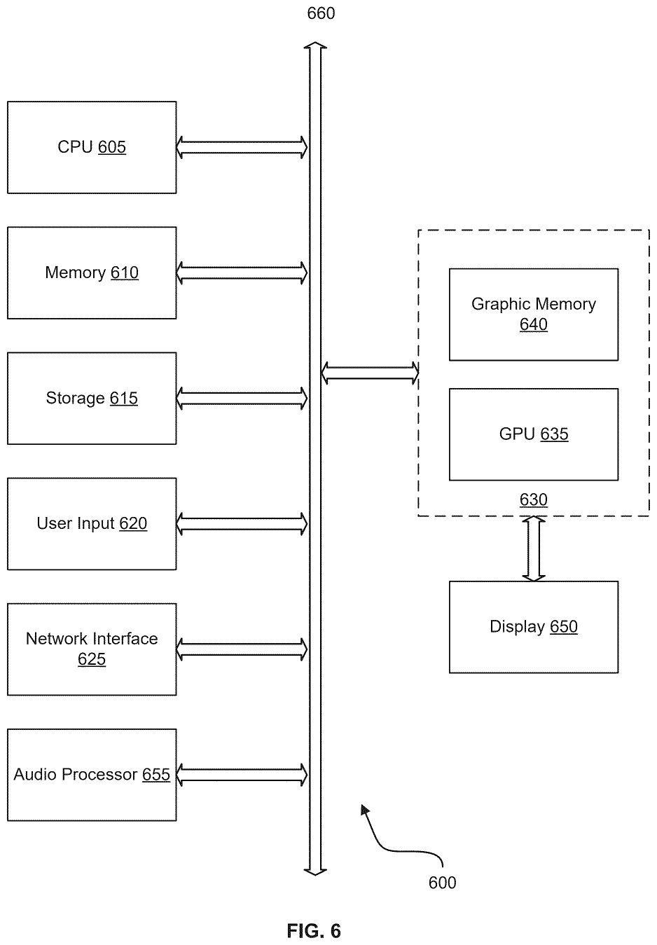

FIG. 6 illustrates an example of a computer system 600 suitable for implementing techniques of the present disclosure, according to embodiments of the present disclosure. The computer system 600 represents, for example, a video game system, a backend set of servers, or other types of a computer system. The computer system 600 includes a central processing unit (CPU) 605 for running software applications and optionally an operating system. The CPU 605 may be made up of one or more homogeneous or heterogeneous processing cores. Memory 610 stores applications and data for use by the CPU 605. Storage 615 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 620 communicate user inputs from one or more users to the computer system 600, examples of which may include keyboards, mice, thumbsticks, touch pads, touch screens, still or video cameras, and/or microphones. Network interface 625 allows the computer system 600 to communicate with other computer systems via an electronic communications network and may include wired or wireless communication over local area networks and wide area networks such as the Internet. An audio processor 655 is adapted to generate analog or digital audio output from instructions and/or data provided by the CPU 605, memory 610, and/or storage 615. The components of computer system 600, including the CPU 605, memory 610, data storage 615, user input devices 620, network interface 625, and audio processor 655 are connected via one or more data buses 660.

A graphics subsystem 630 is further connected with the data bus 660 and the components of the computer system 600. The graphics subsystem 630 includes a graphics processing unit (GPU) 635 and graphics memory 640. The graphics memory 640 includes a display memory (e.g., a frame buffer) used for storing pixel data for each pixel of an output image. The graphics memory 640 can be integrated in the same device as the GPU 635, connected as a separate device with the GPU 635, and/or implemented within the memory 610. Pixel data can be provided to the graphics memory 640 directly from the CPU 605. Alternatively, the CPU 605 provides the GPU 635 with data and/or instructions defining the desired output images, from which the GPU 635 generates the pixel data of one or more output images. The data and/or instructions defining the desired output images can be stored in the memory 610 and/or graphics memory 640. In an embodiment, the GPU 635 includes 3D rendering capabilities for generating pixel data for output images from instructions and data defining the geometry, lighting, shading, texturing, motion, and/or camera parameters for a scene. The GPU 635 can further include one or more programmable execution units capable of executing shader programs.

The graphics subsystem 630 periodically outputs pixel data for an image from the graphics memory 640 to be displayed on the display device 650. The display device 650 can be any device capable of displaying visual information in response to a signal from the computer system 600, including CRT, LCD, plasma, and OLED displays. The computer system 600 can provide the display device 650 with an analog or digital signal.

In accordance with various embodiments, the CPU 605 is one or more general-purpose microprocessors having one or more processing cores. Further embodiments can be implemented using one or more CPUs 605 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method comprising, by a cloud server system executing a gaming application:
determining that a remote client device is executing an integrated development environment in a debugging mode for code associated with the gaming application;
responsive to determining that the remote client device is executing the integrated development environment in the debugging mode, determining a set of available debugging steps for the code in the debugging mode;
generating, for each debugging step in the set of available debugging steps, an output by executing an associated portion of the code;
detecting, from the remote client device, a selected debugging step from the set of available debugging steps; and
responsive to detecting the selected debugging step, providing the associated output to the remote client device.

2. The method of claim 1, wherein the output for each debugging step in the set of available debugging steps is generated prior to detecting the selected debugging step.

3. The method of claim 1, wherein generating the output further comprises at least one of generating a game state for the gaming application or generating a rendering of a video game frame for the gaming application.

4. The method of claim 1, wherein the set of available debugging steps comprises at least one of stepping over a function in the code, stepping into a function in the code, or stepping out of a function in the code.

5. The method of claim 1, wherein the output is a first output, and wherein the method further comprises:
determining that a gaming console is streaming gaming content of the gaming application;
determining a set of available gaming inputs that are selectable in the gaming content; and
generating, for each gaming input in the set of available gaming inputs, a second output by executing the gaming application.

6. The method of claim 5, further comprising:
detecting, from the gaming console, a selected gaming input from the set of available gaming inputs, wherein the second output is generated prior to detecting the selected gaming input; and
responsive to detecting the selected gaming input, providing the associated second output to the gaming console.

7. The method of claim 1, wherein detecting the selected debugging step further comprises:
receiving, from the remote client device, a natural language request indicating the selected debugging step; and
generating, at least by executing a large language model, an action to be performed based on the natural language request.

8. A server system comprising:
one or more processors; and
one or more memories storing computer-readable instructions that, upon execution by the one or more processors, configure the server system to:
determine that a remote client device is executing an integrated development environment in a debugging mode for code associated with a gaming application that is executed by the server system;
responsive to determining that the remote client device is executing the integrated development environment in the debugging mode, determine a set of available debugging steps for the code in the debugging mode;
generate, for each debugging step in the set of available debugging steps, an output by executing an associated portion of the code;
detect, from the remote client device, a selected debugging step from the set of available debugging steps; and
responsive to detecting the selected debugging step, provide the associated output to the remote client device.

9. The server system of claim 8, wherein the one or more processors are further configured to execute the computer-readable instructions to generate the output for each debugging step in the set of available debugging steps prior to detecting the selected debugging step.

10. The server system of claim 8, wherein the one or more processors are further configured to execute the computer-readable instructions to generate the output by performing at least one of:
generating a game state for the gaming application; or
generating a rendering of a video game frame for the gaming application.

11. The server system of claim 8, wherein the set of available debugging steps comprises at least one of stepping over a function in the code, stepping into a function in the code, or stepping out of a function in the code.

12. The server system of claim 8, wherein the output is a first output, and wherein the one or more processors are further configured to execute the computer-readable instructions to:
determine that a gaming console is streaming gaming content of the gaming application;
determine a set of available gaming inputs that are selectable in the gaming content; and
generate, for each gaming input in the set of available gaming inputs, a second output by executing the gaming application.

13. The server system of claim 12, wherein the one or more processors are further configured to execute the computer-readable instructions to:
detecting, from the gaming console, a selected gaming input from the set of available gaming inputs, wherein the second output is generated prior to detecting the selected gaming input; and
responsive to detecting the selected gaming input, providing the associated second output to the gaming console.

14. The server system of claim 8, wherein the one or more processors are further configured to detect the selected debugging step by at least:
receiving, from the remote client device, a natural language request indicating the selected debugging step; and
generating, at least by executing a large language model, an action to be performed based on the natural language request.

15. A computer-readable storage medium having stored therein program code instructions that, when executed by a processor in a server system, cause the processor to perform a method comprising:
determining that a remote client device is executing an integrated development environment in a debugging mode for code associated with a gaming application that is executed by the server system;
responsive to determining that the remote client device is executing the integrated development environment in the debugging mode, determining a set of available debugging steps for the code in the debugging mode;
generating, for each debugging step in the set of available debugging steps, an output by executing an associated portion of the code;
detecting, from the remote client device, a selected debugging step from the set of available debugging steps; and
responsive to detecting the selected debugging step, providing the associated output to the remote client device.

16. The computer-readable storage medium of claim 15, wherein the output for each debugging step in the set of available debugging steps is generated prior to detecting the selected debugging step.

17. The computer-readable storage medium of claim 15, wherein generating the output further comprises at least one of generating a game state for the gaming application or generating a rendering of a video game frame for the gaming application.

18. The computer-readable storage medium of claim 15, wherein the set of available debugging steps comprises at least one of stepping over a function in the code, stepping into a function in the code, or stepping out of a function in the code.

19. The computer-readable storage medium of claim 15, wherein the output is a first output, and wherein the computer-readable storage medium further comprises program code instructions that, when executed by the processor, cause the processor to:
determine that a gaming console is streaming gaming content of the gaming application;
determine a set of available gaming inputs that are selectable in the gaming content; and
generate, for each gaming input in the set of available gaming inputs, a second output by executing the gaming application.

20. The computer-readable storage medium of claim 19, wherein the computer-readable storage medium further comprises program code instructions that, when executed by the processor, cause the processor to:
detect, from the gaming console, a selected gaming input from the set of available gaming inputs, wherein the second output is generated prior to detecting the selected gaming input; and
responsive to detecting the selected gaming input, provide the associated second output to the gaming console.
